(19) United States
(12) Patent Application Publication
(10) Pub. No.: US 2024/0059105 A1
(43) Pub. Date: Feb. 22, 2024

(54) DISCRETE SOUND ABSORBERS FOR TIRE CAVITY NOISE REDUCTION

(71) Applicant: 3M INNOVATIVE PROPERTIES COMPANY, St. Paul, MN (US)

(72) Inventors: Zhen WU, Shanghai (CN); Ronald W. GERDES, St. Paul, MN (US); Tongyang SHI, Woodbury, MN (US); Yao LI, Shanghai (CN); Huo Ying LU, St. Paul, MN (US)

(21) Appl. No.: 18/260,846

(22) PCT Filed: Jan. 11, 2022
(86) PCT No.: PCT/IB2022/050180

§ 371 Date: Jul. 10, 2023

Related U.S. Application Data
(60) Provisional application No. 63/135,953, filed on Jan. 11, 2021.

(51) Int. Cl. B60C 19/00

(52) U.S. Cl. CPC B60C 19/002; B60B 2900/133

(57) ABSTRACT

An array of discrete sound absorbers (20a, 20b) is attached to an inner surface (122) of an annular tread portion (12) of a pneumatic tire (10) or an annular rim surface (34) of a wheel rim (30) to reduce tire cavity noise. Each sound absorber (20a, 20b) includes a flexible sheet-like base material (54), a sheet-like screen material (52), and a sound absorbing material (56) disposed in a closed space formed by the sheet-like base material (54) and the sheet-like screen material (52).

### BACKGROUND

Like other air cavities, the cavity enclosed between the tire and the rim of a vehicle wheel has its own resonance frequency. When the frequency of the road excitation meets with the resonance frequency of tire cavity which is around 200 Hz, the tire cavity resonates, resulting in a severe vibration due to the coupling between the tire structure and the tire cavity. The vibration amplifies the spindle force (i.e., the reaction force applied on the rim center), which can be further transmitted through the suspension system into the car cabin. The resulting interior noise, referred to as tire cavity resonance noise (or tire cavity noise for abbreviation) can be easily perceived by passengers. Since the noise is a narrow-band noise at low frequency, it is very annoying and significantly destroys the interior sound quality.

### SUMMARY

There is a desire to reduce tire cavity noise. The present disclosure provides articles and methods to reduce tire cavity noise. In one aspect, the present disclosure describes a sound absorber including a flexible sheet-like base material, a sheet-like screen material, and a sound absorbing material disposed in a closed space formed by the sheet-like base material and the sheet-like screen material, the sound absorbing material extending along a longitudinal direction of the sound absorber.

In another aspect, the present disclosure describes a sound absorber assembly including multiple of the above described sound absorbers. The sound absorbing material of the adjacent sound absorbers are separated by a gap such that the array of sound absorbers are discrete. In some cases, the multiple sound absorbers are connected by a connection portion.

In another aspect, the present disclosure describes a pneumatic tire including an annular tread portion extending in a circumferential direction thereof, and an array of discrete sound absorbers, at least one of the sound absorbers being the above described sound absorber or the above described sound absorber assembly. The discrete sound absorbers each are attached to an inner surface of the annular tread portion, and the array of discrete sound absorbers are distributed along the circumferential direction of the tread portion.

In another aspect, the present disclosure describes a wheel rim including an annular rim surface extending in a circumferential direction thereof, and an array of discrete sound absorbers, at least one of the sound absorbers being the above described sound absorber or the above described sound absorber assembly. The discrete sound absorbers each are attached to the annular rim surface, and the array of discrete sound absorbers are distributed along the circumferential direction of the annular rim surface.

In another aspect, the present disclosure describes a wheel including a pneumatic tire that includes an annular tread portion extending in a circumferential direction thereof, and an array of discrete sound absorbers, at least one of the sound absorbers being the above described sound absorber or the above described sound absorber assembly. The discrete sound absorbers each are attached to an inner surface of the annular tread portion, and the array of discrete sound absorbers are distributed along the circumferential direction of the tread portion.

In another aspect, the present disclosure describes a wheel including a wheel rim that includes an annular rim surface extending in a circumferential direction thereof, and an array of discrete sound absorbers, at least one of the sound absorbers being the above described sound absorber or the above described sound absorber assembly. The discrete sound absorbers each are attached to the annular rim surface, and the array of discrete sound absorbers are distributed along the circumferential direction of the annular rim surface.

In another aspect, the present disclosure describes a method of reducing tire cavity noise. The method includes attaching an array of discrete sound absorbers to at least one of (i) an inner surface of an annular tread portion of a pneumatic tire, and (ii) an annular rim surface of a wheel rim. The pneumatic tire is mounted to the wheel rim to form an enclosed tire cavity. At least one of the sound absorbers is the above described sound absorber or the above described sound absorber assembly.

Various unexpected results and advantages are obtained in exemplary embodiments of the disclosure. One such advantage of exemplary embodiments of the present disclosure is that articles and methods described herein to reduce a tire cavity noise provide a better acoustic performance in terms of a higher energy dissipation at tire cavity resonance and less additional weight effect, relative to the typical solution where a layer of porous, sound-absorbing foam is attached onto the inner surface of the tread portion of the tire.

Various aspects and advantages of exemplary embodiments of the disclosure have been summarized. The above Summary is not intended to describe each illustrated embodiment or every implementation of the present certain exemplary embodiments of the present disclosure. The Drawings and the Detailed Description that follow more particularly exemplify certain preferred embodiments using the principles disclosed herein.

### BRIEF DESCRIPTION OF THE DRAWINGS

The disclosure may be more completely understood in consideration of the following detailed description of various embodiments of the disclosure in connection with the accompanying figures, in which:

FIG. 1′ is an exploded partial view of a tire including a typical sound absorber or noise damper.

FIG. 1A is a schematic cross-sectional view of a tire including an array of discrete sound absorbers, according to one embodiment.

FIG. 1B is a perspective side view of the tire of FIG. 1A.

FIG. 2A is a perspective side view of an array of discrete sound absorbers, according to one embodiment.

FIG. 2B is a perspective side view of an array of discrete sound absorbers, according to another embodiment.

FIG. 3 is a perspective side view of a wheel rim including an array of discrete sound absorbers, according to one embodiment.

FIG. 4A is a perspective side view of an array of discrete sound absorbers, according to one embodiment.

FIG. 4B is a perspective side view of an array of discrete sound absorbers, according to another embodiment.

FIG. 5 is a schematic cross-sectional view of a sound absorber assembly, according to one embodiment.

FIG. 6A is a perspective side view of a sound absorber assembly, according to one embodiment.

FIG. 6B is a perspective side view of a sound absorber assembly, according to another embodiment.

FIG. 7A is a perspective bottom view of a sound absorber assembly, according to one embodiment.

FIG. 7B is a perspective bottom view of a sound absorber assembly, according to another embodiment.

FIG. 8 is a schematic front view of acoustic test setups.

In the drawings, like reference numerals indicate like elements. While the above-identified drawing, which may not be drawn to scale, sets forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

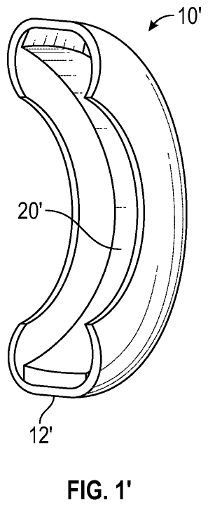

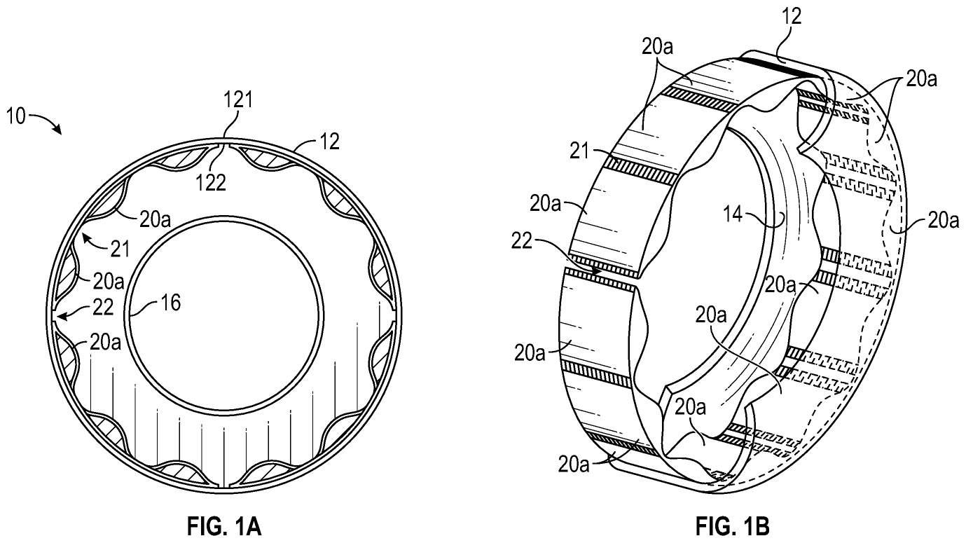

One typical solution for reducing tire cavity noise of a wheel is to adhere a layer of porous, sound-absorbing foam onto the inner surface of the tread portion of the tire. The foam layer continuously extends in the tire circumferential direction. FIG. 1′ is an exploded partial view of a tire 10′ including a continuous foam layer 20′ attached to the inner surface of the tread portion 12′ of the tire 10′. The continuous foam layer 20′ extends in the tire circumferential direction to form a substantially closed loop. This solution has been widely adopted by commercially available tires and wheels of vehicles. For example, a continuous polyurethane (PU) foam layer has been attached onto the inner tread of a vehicle tire to reduce tire cavity noise.

The present disclosure found that the traditional solution such as shown in FIG. 1′ may have several technical shortcomings. First, the acoustic performance of polyurethane (PU) foam is relatively low compared to other fibrous acoustic material. The normal incident sound absorbing coefficient of a 25 mm thick PU foam sample in the desired frequency range 100 Hz to 300 Hz is less than 0.1. Consequently, polyurethane (PU) foam may not be a desired material for tire cavity noise reduction, though it has been widely used due to its low material cost. In addition, the labor cost for adhering the continuous PU foam layer onto the tire is another concern from the tire manufactures. To achieve a better adhesive condition, commonly a pre-process of grinding away the mold release layer (with a thickness less than 0.5 mm) on the inner surface of tread is performed before the adhering process. Consequently, the larger the area of the continuous foam layer adhering to the tire, the higher the additional labor cost. For a typical automobile tire, for example, the area to be pre-processed can be around 0.3 to 0.6 m². The adhesive area is also proportional to the material cost of adhesive. Furthermore, when a tire with the PU foam layer is punctured, the portion of the PU foam covering the punctured area needs to be removed before the repairing work. It may be difficult and expensive to remove the whole PU foam layer and replace it with a new one. In real practice, the PU foam layer attached to the tire usually has a thickness of 25 mm and a width ranging from 150 mm to 180 mm. A typical tire perimeter may be, for example, 2.372 m. Correspondingly, the volume of the PU foam layer is 8.9×10⁻³ m³ and the weight is 445 g, assuming the density of the PU foam is 50 kg/m³ and the width is 150 mm. Such an additional weight may degrade the fuel efficiency of the tire.

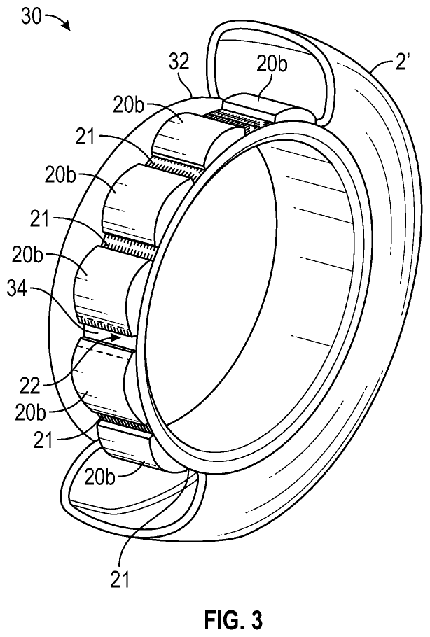

Some embodiments of articles and methods described herein are provided to reduce tire cavity noise while addressing the above issues for the traditional solution. The approach described herein provides a better acoustic performance in terms of a higher energy dissipation at tire cavity resonance and less additional weight effect, relative to the typical solution where a layer of porous, sound-absorbing foam is attached onto the inner surface of the tread portion of the tire. FIG. 1A is a schematic cross-sectional view of a pneumatic tire 10 with an array of discrete sound absorbers 20a, according to one embodiment. FIG. 1B is a perspective side view of the tire 10 of FIG. 1A. The pneumatic tire 10 forms a substantially annular shape and includes a tread portion 12, a pair of sidewall portions 14, and a pair of axially spaced bead portions 16. The sidewall portions 14 extends radially and inwardly from the edges of the tread portion 12 and the bead portions 16 are disposed at the inner edges of the sidewall portions 14. The tread portion 12 has an outer surface 121 and an inner surface 122 opposite the outer surface 121. When the pneumatic tire 10 is mounted on a wheel rim such as a wheel rim 30 of FIG. 3 to be described further below, the open tire hollow is closed, and an annular closed tire cavity is formed. In some embodiments, the cavity-facing inner surface of the tire 10 may be covered with an inner liner rubber having a low air permeability.

The pneumatic tire 10 may be, for example, a tubeless radial tire for a passenger vehicle. The pneumatic tire 10 may be made of a form used for passenger vehicles where quietness in the cabin is strongly desired, or may be a tire for a variety of uses such as for a truck, a motorcycle, an aircraft, a bicycle, a trailer, or the like. Additionally, the pneumatic tire 10 may be a bias tire.

In the embodiment depicted in FIG. 1A, an array of discrete sound absorbers 20a are attached to the inner surface 122 of the tread portion 12. The sound absorbers 20a are distributed along the circumferential direction of the pneumatic tire 10. The sound energy dissipates when the sound wave propagates through one sound absorber to the next one. Each sound absorber 20a is attached to the inner surface 122 of the tread portion 12 via, for example, an adhesive or adhesive tape. The adhesive or adhesive tape can resist a high temperature, for example, no less than 80 degrees Celsius. Exemplary adhesive tapes include those commercially available from, for example, 3M Company (St. Paul, MN) under the trade designation 9988EG. In many applications, the bonding between the sound absorber 20a and the inner surface 122 of the pneumatic tire can resist cyclic loads no less than 800,000 cycles under the standard of GB/T 4502-2016 (ISO 10191), which specifies the durability test where the lowest rolling speed is 80 km/h and the time duration is 34 hours.

The sound absorbers 20a are distributed discretely along the circumferential direction of the pneumatic tire 10. The sound absorbers 20a are considered to be discrete because the sound absorbing material of the adjacent sound absorbers are separated by a gap. The length dimension of the sound absorbers 20a along the circumferential direction of the tire 10 may be in the range, for example, from about 3 mm to about 2.5 m, from about 10 mm to about 1 m, or from about 15 mm to about 0.5 m. The length dimension of the sound absorbers 20a along the circumferential direction of the tire 10 may be in the range, for example, from about 0.1% to about 100%, from about 5% to about 99%, from about 10% to about 99%, or from about 20% to about 95% of the circumferential length of the inner surface 122 of the tire 10.

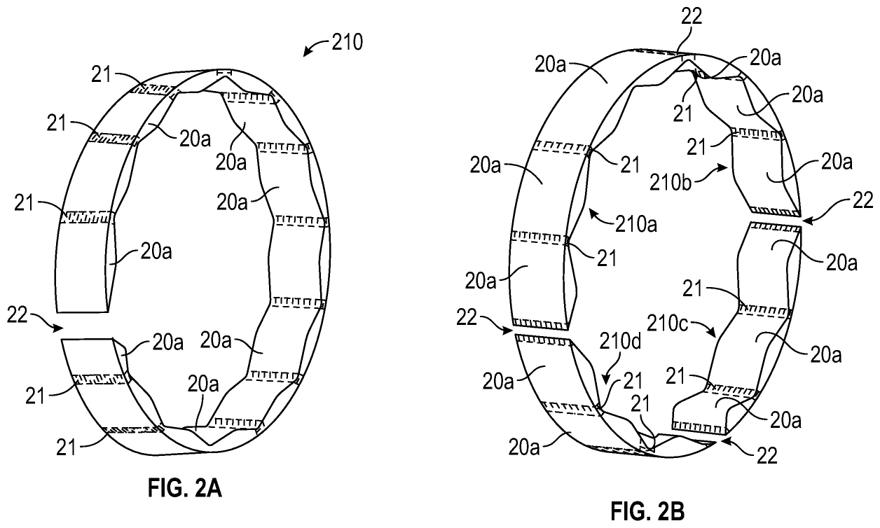

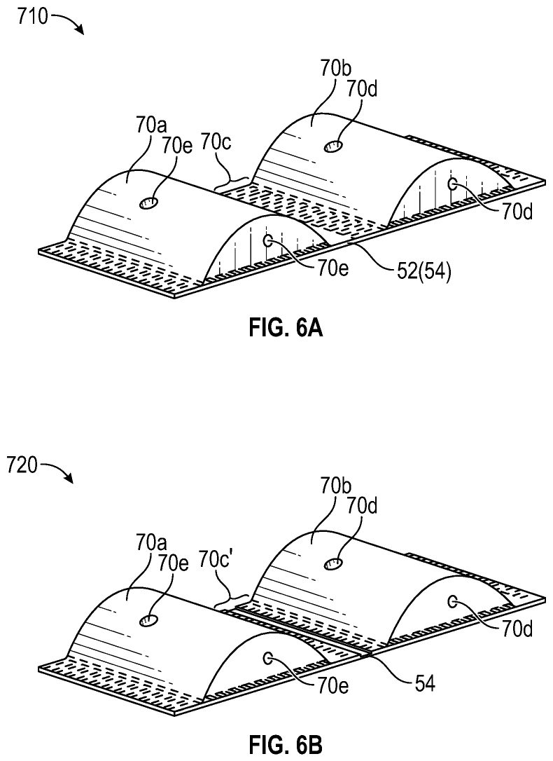

In some embodiments, the neighboring sound absorbers may be connected by a connection portion such as, for example, the connection portion 21 of FIGS. 2A-B (or 70c of FIG. 6A and FIG. 6B), which will be described further below. In some embodiments, the adjacent sound absorbers may not be connected. For example, in the embodiment depicted in FIGS. 2A-B, there is a gap 22 between the adjacent sound absorbers 20a along the circumferential direction of the tire 10. The connection portion 21 or the gap 22 may have a length dimension along the circumferential direction in the range, for example, from about 1% to about 100% of the length of a sound absorber. The sound absorbers 20a may be evenly distributed in the circumferential direction of the tire 10. It is to be understood that while the adjacent sound absorbers can be connected by a connection portion, the sound absorbing material of the adjacent sound absorbers can be separated by a gap such that the sound absorbers can be considered as discrete.

The sound absorbers 20a may have a width along a direction substantially perpendicular to the circumferential direction of the tire 10 in the range, for example, from about 5 mm to about 250 mm. The width of the sound absorbers may be in the range, for example, from about 1% to about 150% of a tread width of the tread portion 12. The tread width of the tread portion 12 of the pneumatic tire 10 is not particularly limited, but may be a width of from 60 mm to 315 mm. The term “tread width” means the width of the portion where the pneumatic tire 10 contacts the road surface in a cross-sectional view including the center axis of the pneumatic tire 10. The tread width is not limited to the width of the tread portion 12 actually measured, and may be a width dimension given in terms of standard designation.

FIG. 2A depicts a sound absorber assembly 210, according to one embodiment. The sound absorber assembly 210 includes an array of sound absorbers 20a to be attached to the inner surface 122 of the tread portion 12 of FIG. 1A. Adjacent sound absorbers 20a are connected by the respective connection portions 21 to form a continuous tape, band, or strip. It is to be understood that while the adjacent sound absorbers 20a are connected by the connection portion 21, the connection portion 21 may contain substantially no sound absorbing material such that the sound absorbing material of the adjacent sound absorbers is discrete. When the sound absorber assembly 210 is mounted on the inner surface of a tire tread portion, a gap 22 is formed between the head and the tail of the sound absorber assembly 210. In some cases, when the sound absorber assembly 210 is mounted on the inner surface of a tire tread portion, a connection portion 21 may connect the head and the tail of the sound absorber assembly 210, forming a closed loop.

FIG. 2B depicts an array of sound absorbers 20a arranged as multiple discrete sound absorber assemblies, which can be attached to the inner surface 122 of the tread portion 12 of FIG. 1A. Adjacent sound absorbers 20a are connected by the respective connection portions 21 to form sound absorber assemblies 210a, 210b, 210c or 210d, which are separated by gaps 22 when mounted on the inner surface of a tire tread portion. It is to be understood that this layout is beneficial for replacing the damaged sound absorbers with a new one without replacing the whole array of discrete sound absorbers. It is to be understood that a sound absorber assembly can be formed by connecting any number of adjacent sound absorbers. It is also to be understood that the array of sound absorbers can include any number of sound absorber assemblies.

FIG. 3 is a perspective side view of a wheel rim 30 including an array of discrete sound absorbers 20b, according to one embodiment. The wheel rim 30 includes a pair of bead seats 32 on which tire bead portions such as the bead portions 16 of FIG. 1A seat. The wheel rim 30 has a rim surface 34. When a pneumatic tire is mounted on the wheel rim 30, the open tire hollow is closed and an annular closed tire cavity is formed, where the rim surface 34 of the wheel rim 30 faces the annular closed tire cavity.

In the embodiment depicted in FIG. 3, the array of discrete sound absorbers 20b are attached to the rim surface 34. The sound absorbers 20b are distributed along the circumferential direction of the wheel rim 30. Each sound absorber is attached to the rim surface 34 via, for example, an adhesive or adhesive tape. The adhesive or adhesive tape can resist a high temperature, for example, no less than 80 degrees Celsius. Exemplary adhesive tapes include those commercially available from, for example, 3M Company (St. Paul, MN) under the trade designation 9988EG. In many applications, the bonding between the sound absorber 20a and the rim surface 34 of the wheel rim 30 can resist cyclic loads no less than 800,000 cycles under the standard of GB/T 4502-2016 (ISO 10191), which specifies the durability test where the lowest rolling speed is 80 km/h and the time duration is 34 hours.

The sound absorbers 20b are distributed discretely along the circumferential direction of the wheel rim 30. The sound absorbers 20b are considered to be discrete because the sound absorbing material of the adjacent sound absorbers are separated by a gap. The energy of sound wave dissipates when the sound wave passes through from one sound absorber to the other. The length dimension of the sound absorbers 20b along the circumferential direction of the wheel rim 30 may be in the range, for example, from about 3 mm to about 2.5 m, from about 10 mm to about 1 m, or from about 15 mm to about 0.5 m. The length dimension of the sound absorbers 20b along the circumferential direction of the wheel rim 30 may be in the range, for example, from about 0.15% to about 100%, from about 5% to about 99%, from about 10% to about 99%, or from about 20% to about 95% of the circumferential length of the rim surface 34.

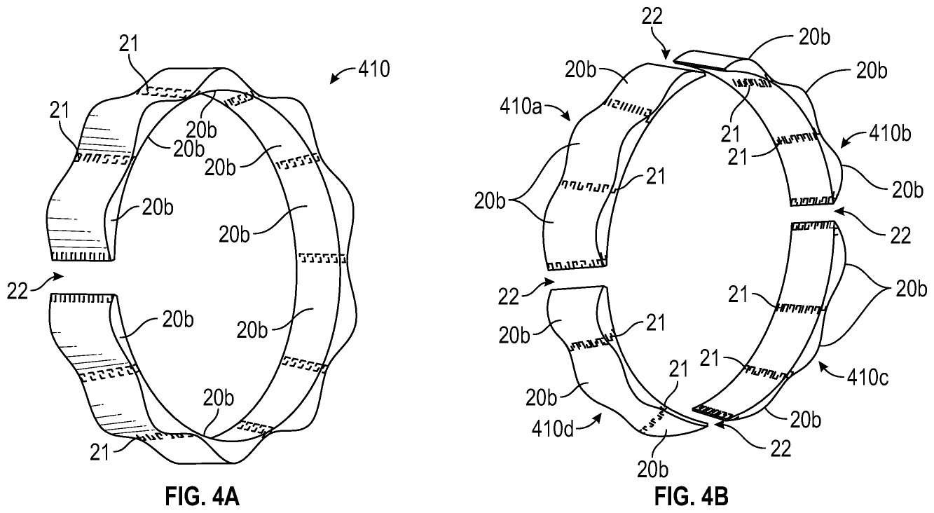

The adjacent sound absorbers 20b can be connected by a connection portion 21 or separated by a gap 22. The connection portion 21 or the gap 22 may have a length dimension along the circumferential direction in the range, for example, from about 1% to about 100% of the length of the sound absorber. In some embodiments, the neighboring sound absorbers may be connected by a connection portion such as, for example, the connection portion 70c of FIG. 4, which will be described further below. The sound absorbers 20b may be evenly distributed in the circumferential direction of the wheel rim 30. It is to be understood that while the adjacent sound absorbers can be connected by a connection portion, the sound absorbing material of the adjacent sound absorbers can be separated by a gap such that the sound absorbers can be considered as discrete.

The sound absorbers 20b may have a width along a direction substantially perpendicular to the circumferential direction of the wheel rim 30 in the range, for example, from about 5 mm to about 200 mm. The width of the sound absorbers may be in the range, for example, from about 1.5% to about 100% of a rim width of the wheel rim 30. The width of the wheel rim 30 is not particularly limited, but may be a width of from 127 mm to 317.5 mm. The term “rim width” means the axial distance between the pair of bead seats 32.

FIG. 4A depicts a sound absorber assembly 410, according to one embodiment. The sound absorber assembly 410 includes an array of sound absorbers 20b to be attached to the rim surface 34 of the rim 30 of FIG. 3. Adjacent sound absorbers 20b are connected by the respective connection portions 21 to form a continuous tape. When the sound absorber assembly 410 is mounted on the rim surface 34, a gap 22 is formed between the head and the tail of the sound absorber assembly 410. In some cases, when the sound absorber assembly 410 is mounted on the rim surface 34 of the rim 30, a connection portion 21 may connect the head and the tail of the sound absorber assembly 410, forming a closed band. It is to be understood that this closed-loop configuration is beneficial for resisting the centrifugal force as the wheel is rolling. In some cases, the connection portions 21 in the closed-band configuration may be made of heat-shrinkable film. When the heat-shrinkable film is heated, e.g., in an oven or with a heat gun, the closed-band configuration can shrink its circumferential length so that the discrete sound absorbers 20b can be firmly bonded to the rim 30.

FIG. 4B depicts an array of sound absorbers 20b arranged as multiple discrete sound absorber assemblies, which can be attached to the rim surface 34 of the rim 30 of FIG. 3. Adjacent sound absorbers 20b are connected by the respective connection portions 21 to form sound absorber assemblies 410a, 410b, 410c or 410d, which are separated by gaps 22 when mounted on the rim. It is to be understood that this layout is beneficial for replacing the damaged sound absorbers with a new one without replacing the whole array of discrete sound absorbers. It is to be understood that a sound absorber assembly can be formed by connecting any number of adjacent sound absorbers. It is also to be understood that the array of sound absorbers can include any number of sound absorber assemblies.

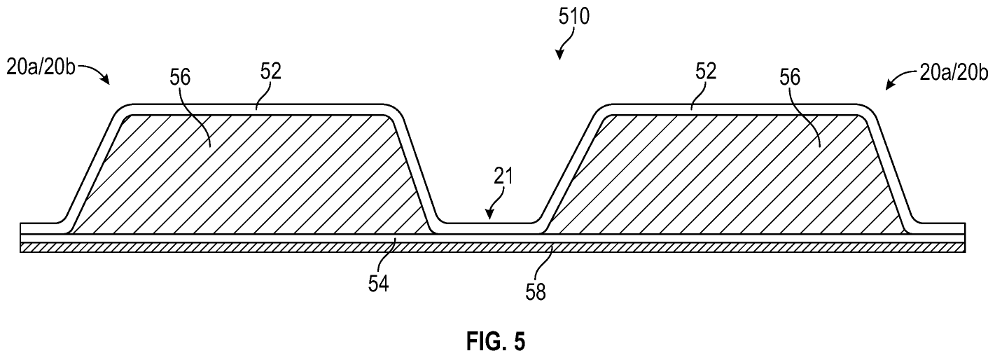

FIG. 5 is a schematic cross-sectional view of a sound absorber assembly 510, according to one embodiment. The sound absorber assembly 510 includes multiple sound absorbers 20a (e.g., see FIG. 1A) or sound absorbers 20b (e.g., see FIG. 3). Each sound absorber 20a or 20b includes a sheet-like screen material 52 and a sheet-like base material 54, which are connected at the respective peripheries to form a closed space. A sound absorbing material 56 is disposed in the closed space formed by the base material 54 and the screen material 52. An adhesive element 58 is provided to attach the sound absorber assembly 510 onto a surface. Adjacent sound absorbers 20a or 20b can be connected by a connection portion 21, which can include at least one of the sheet-like screen material 52, the sheet-like base material 54, or the adhesive element 58 extending into the gap region between the adjacent sound absorbers 20a or 20b. It is to be understood that the connection portion 21 can include other suitable materials to connect the adjacent sound absorbers 20a or 20b. The connection portion 21 may contain substantially no sound absorbing material 56 and the adjacent sound absorbing materials 56 are discrete.

When the sound absorber assembly 510 is in use, the screen material 52 faces toward the air cavity when the sound absorbers are attached to a rim surface (e.g., the rim surface 34 of the rim 30 in FIG. 3) or to a tire tread portion (e.g., the inner surface 122 of the tread portion 12 in FIG. 1A). The screen material 52 can include one or more sheet-like materials such as, for example thermoplastic polyurethane (TPU) film. From mechanical perspective, it is to be understood that the screen material may protect the sound absorbing material when the sound absorber undergoes large deformation as the tire deforms or as the rim rotates. From acoustic perspective, it is to be understood that the screen material may change the low frequency absorption of the sound absorbing material 56. The acoustic performance of the screen material is determined by its acoustic impedance Z, which is a complex function of its areal density and flow resistance. An analysis formulation describing this relationship is

$$\\ Z = \frac{1}{\frac{1}{2 π i \times {ρ}_{area}} + \frac{1}{{R}_{f}}} ,$$

where ρₐᵣₑₐ is the areal density of the screen material and R_{f} is its flow resistance. The term “areal density” is defined as the mass per unit area. The term “flow resistance” indicates the air permeability of one material, which can be measured according to the test standard ASTM C522 or ISO 9053. For a suitable screen material, its areal density can be, for example, from about 0.5 g/m² to 10000 g/m², or from about 1 g/m² to 1000 g/m². Its flow resistance can be, for example, no less than 0.01 mks rayls, no less than 1 mks rayls, or no less than 1000 mks rayls.

In some embodiments, an air impermeable screen material (e.g., a TPU film) can be used. The term “air impermeable” refers to an infinite large flow resistance R_{f} in the above formulation, indicating that the impermeable screen material introduces a pure reactance impedance. It is to be understood that the pure reactance impedance of an air impermeable screen material is beneficial for increasing the low frequency absorption of a sound absorber.

In some embodiments, a porous screen material (e.g., an acoustic mesh fabric) may be used. A porous material has a relatively small value of flow resistance R_{f}, compared to an air impermeable material. A porous screen material may introduce an almost pure resistance impedance, i.e., Z≈R_{f}. Consequently, the existence of the porous screen material may not increase the low frequency absorption of a sound absorber, while it may increase the surface impedance of the sound absorber by R_{f}. The term “surface impedance” is defined as the acoustic impedance measured at the surface of the sound absorber.

The base material 54 can include one or more flexible materials such as, for example, a polyurethane (PU) film. It is to be understood that the base material may include any suitable flexible material having the ability of desired deformation when attached to a curved surface (e.g., a rim surface or an inner surface of a tire tread portion). The base material 54 is stretchable or conformable such that when it receives a strain or stretch from a surface it is attached to, the base material 54 can deform correspondingly without affecting the mechanical integrity of the sound absorber. In some embodiments, the maximum elongation until failure of the base material can be, for example, no less than 105%, no less than 110%, or no less than 115%. When the sound absorber is disposed on the inner surface of a wheel tire, the base material may receive a periodical strain transferred from the tread portion, and may generate a heat as a result of repetition of ground contacting and ground non-contacting of the tread portion of the wheel tire. The base material can be water and oil proofing itself or have a water and oil proofing coating thereon.

The sound absorbing material 56 is disposed in the closed space formed by the base material 54 and the screen material 52. In some embodiments, the sound absorbing material is made from nonwoven fibers. It is to be understood that the sound absorbing material may include any suitable flexible material having sound attenuation as the sound wave passes through the porous microstructure of the sound absorbing material. The flow resistivity of sound absorbing material is one key material parameter for determining its sound attenuation performance. In some embodiments, the flow resistivity of sound absorbing material may be in the range, for example, from about 1000 mks rayls/m to about 50000 mks rayls/m, from about 2000 mks rayls/m to about 20000 mks rayls/m, from about 3000 mks rayls/m to about 10000 mks rayls/m, or from about 4000 mks rayls/m to about 6000 mks rayls/m. The term “flow resistivity” is defined as the ratio of the flow resistance to the thickness. The maximum temperature that sound absorbing material can resist may be in the range, for example, from about 80 degrees Celsius to about 180 degrees Celsius.

In some embodiments, the sound absorbing material 56 and the impermeable screen material 52 may not be closely attached or bonded to each other such that an air gap exists due to the loose connection between the two materials. The air gap therebetween can further increase the low frequency absorption of the sound absorber.

The thickness of the sound absorbing material 56 may be in the range, for example, from about 0.5 mm to about 200 mm, from about 1 mm to about 100 mm, or from about 5 mm to about 50 mm. The length dimension of the sound absorbing material 56 along the longitudinal direction of the base material may be in the range, for example, from about 3 mm to about 2 m. The width dimension of the sound absorbing material perpendicular to the longitudinal direction of the base material may be in the range, for example, from about 5 mm to about 250 mm.

In some embodiments, vent holes can be provided on a screen material (e.g., the screen material 52 of FIG. 5), for balancing the air pressure between inside and outside of the sound absorber. In the embodiments depicted in FIGS. 6A-B, the sound absorber assemblies 710 and 720 each include two sound absorbers or absorbing patches 70a and 70b connected side by side via a connection portion 70c or 70c′. Each of the sound absorbing patches 70a and 70b may have a configuration similar to the sound absorber 20a or 20b shown in FIG. 5. As shown in FIG. 6A, the connection portion 70c connects the two adjacent sound absorbing patches and may include the sheet-like screen material 52 and a sheet-like base material 54 of the sound absorber 510. In another embodiment as depicted in FIG. 6B, at least a portion of the connection portion 70c′ may include the sheet-like base material 54, but not the screen material 52. From a mechanical perspective, with the connection portion 70c or 70c′, the sound absorber assembly 710 or 720 can be easily bended and can be easily accommodated to various rim surface 34 and various inner surface 122 of the tread portion 12. From acoustic perspective, the connection portion 70c or 70c′ may introduce an acoustic impedance change between two adjacent sound absorbers when the sound wave propagates from one sound absorber to the other, providing more energy dissipation. The connection portion 70c is also beneficial for repairability. When one sound absorber of the sound absorber assembly is damaged and is needed to be replaced by a new one, it is easy to cut the sound absorber to be replaced at the connection portion. The vent holes 70d/70e are placed on the screen material 52, for balancing the air pressure between inside and outside of the sound absorber. It is to be understood that the vent holes 70d/70e can be made of a porous material to achieve similar functions.

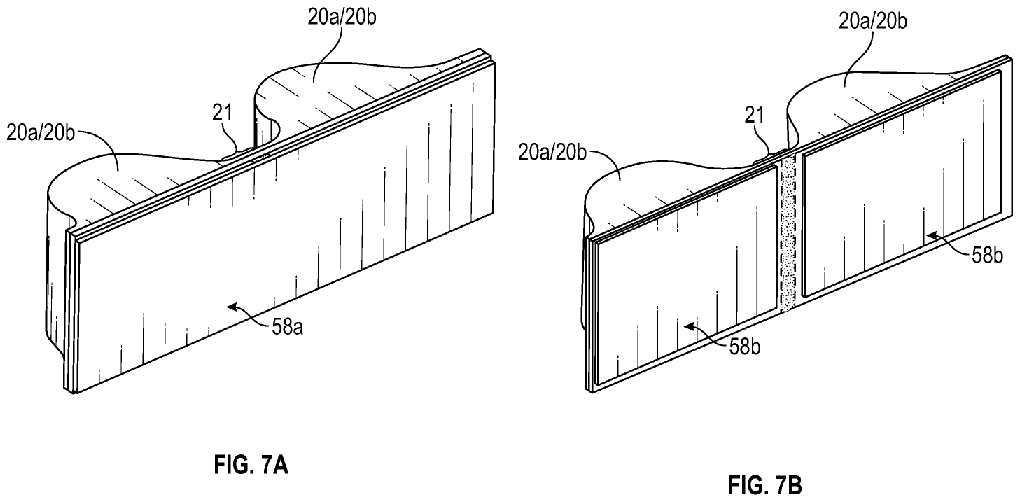

Referring again to FIG. 5, the adhesive element 58 is provided to attach the sound absorber assembly 510 onto a surface. FIGS. 7A-B illustrate various configurations and arrangements of adhesive layer(s) or tape(s). In FIG. 7A, a continuous layer of adhesive or adhesive element 58a is attached to the base sheet-like material underneath adjacent sound absorbers 20a/20b. The adhesive or adhesive element 58a extends continuously across the connection portion 21. The continuous layout of adhesive or adhesive tapes is beneficial for ease of manufacturing. In FIG. 7B, discontinuous adhesive or adhesive tapes 58b are attached to the base materials underneath the respective sound absorbers 20a/20b. The adhesive layers or adhesive tapes 58b are not connected at the connection portion 21. It is to be understood that the discontinuous layout of adhesive or adhesive tapes is beneficial for repairability when one sound absorber is needed to be replaced.

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Exemplary embodiments of the present disclosure may take on various modifications and alterations without departing from the spirit and scope of the present disclosure. Accordingly, it is to be understood that the embodiments of the present disclosure are not to be limited to the following described exemplary embodiments, but is to be controlled by the limitations set forth in the claims and any equivalents thereof.

### Listing of Exemplary Embodiments

Exemplary embodiments are listed below. It is to be understood that any one of embodiments 1-14, 15-17, 18-23, 24-29, 30, 31 and 32-34 can be combined.

Embodiment 1 is a sound absorber comprising:
a flexible sheet-like base material;
a sheet-like screen material; and
a sound absorbing material disposed in a closed space formed by the sheet-like base material and the sheet-like screen material, the sound absorbing material extending along a longitudinal direction of the sound absorber.
   Embodiment 2 is the sound absorber of embodiment 1, wherein the flexible sheet-like base material has a stretchability along the longitudinal direction no less than about 105%, no less than about 110%, or optionally, no less than about 115%.
   Embodiment 3 is the sound absorber of embodiment 1 or 2, wherein the flexible sheet-like base material includes a water and oil proofing material.
   Embodiment 4 is the sound absorber of any one of embodiments 1-3, wherein the flexible sheet-like base material comprises at least one of rubber film, polyurethane (PU) film, thermoplastic polyurethane (TPU) film, polypropylene (PP) film, cast polypropylene (CPP) film, polyethylene terephthalate (PET), cast polyethylene terephthalate (CPET) film, or TPU/PU coated fabric.
   Embodiment 5 is the sound absorber of any one of embodiments 1-4, wherein the sheet-like screen material has a flow resistivity no less than 0.01 mks rayls, no less than 1 mks rayls, or no less than 1000 mks rayls.
   Embodiment 6 is the sound absorber of any one of embodiments 1-5, wherein the sheet-like screen material has an areal density from about 0.5 g/m² to 10000 g/m², or from about 1 g/m² to 1000 g/m².

Embodiment 7 is the sound absorber of any one of embodiments 1-6, wherein the sheet-like screen material comprises at least one of mesh fabric, nonwoven fabric, woven fabric, rubber film, polyurethane (PU) film, thermoplastic polyurethane (TPU) film, polypropylene (PP) film, cast polypropylene (CPP) film, polyethylene terephthalate (PET) film, cast polyethylene terephthalate (CPET) film, or TPU/PU coated fabric.

Embodiment 8 is the sound absorber of any one of embodiments 1-7, wherein one or more vent holes are formed on the sheet-like screen material.
Embodiment 9 is the sound absorber of any one of embodiments 1-8, wherein the sound absorbing material comprises at least one of polyurethane (PU) foam, glass fiber material, mineral fiber material, polyester fiber material, polypropylene fiber material, nonwoven fiber material embedded with sound absorbing particles, or a combination thereof.
Embodiment 10 is the sound absorber of any one of embodiments 1-9, wherein the sound absorbing material has a flow resistivity in the range from about 1000 mks rayls/m to about 50000 mks rayls/m, optionally, from about 4000 mks rayls/m to about 6000 mks rayls/m.
Embodiment 11 is the sound absorber of any one of embodiments 1-10, wherein the sound absorbing material has a thickness in the range from about 0.5 mm to about 200 mm, optionally, from 5 mm to about 50 mm.
Embodiment 12 is the sound absorber of any one of embodiments 1-11, wherein the sound absorbing material has a length along the longitudinal direction in the range from about 3 mm to about 2.5 m.
Embodiment 13 is the sound absorber of embodiment any one of embodiments 1-12, wherein the sound absorbing material has a width in the range from about 5 mm to about 200 mm.
Embodiment 14 is the sound absorber of any one of embodiments 1-13, further comprising an adhesive layer disposed on the flexible sheet-like base material.
Embodiment 15 is a sound absorber assembly comprising a plurality of the sound absorbers of any one of embodiments 1-14, wherein the sound absorbing material of the adjacent sound absorbers are separated by a gap.
Embodiment 16 is the sound absorber assembly of embodiment 15, wherein the plurality of the sound absorbers is connected by a connection portion.
Embodiment 17 is the sound absorber assembly of embodiment 16, wherein the connection portion comprises substantially no sound absorbing material.
Embodiment 18 is a pneumatic tire comprising:
an annular tread portion extending in a circumferential direction thereof; and
an array of discrete sound absorbers, at least one of the sound absorbers being the sound absorber of any one of embodiments 1-14 or the sound absorber assembly of any one of embodiments 15-17,
wherein the discrete sound absorbers each are attached to an inner surface of the annular tread portion, and the array of discrete sound absorbers are distributed along the circumferential direction of the tread portion.
   Embodiment 19 is the pneumatic tire of embodiment 18, wherein the flexible sheet-like base material of the at least one sound absorber is elongated along the circumferential direction of the tread portion.
   Embodiment 20 is the pneumatic tire of embodiment 18 or 19, wherein the discrete sound absorbers each are attached to the inner surface of the annular tread portion via an adhesive layer.
   Embodiment 21 is the pneumatic tire of any one of embodiments 18-20, wherein the array of discrete sound absorbers includes at least two, at least three, at least four, at least five, or optionally, at least six of the sound absorbers.
   Embodiment 22 is the pneumatic tire of any one of embodiments 18-21, wherein the array of discrete sound absorbers has a total length along the circumferential direction of the tread portion in the range from 1% to 100% of a circumferential length of the inner surface of the tread portion.
   Embodiment 23 is the pneumatic tire of any one of embodiments 18-22, wherein the sound absorbing material of the adjacent sound absorbers are separated by a gap, the gap having a length along the circumferential direction of the tread portion in the range from 1% to 99% of a circumferential length of the inner surface of the tread portion.
   Embodiment 24 is a wheel rim comprising:
an annular rim surface extending in a circumferential direction thereof; and
an array of discrete sound absorbers, at least one of the sound absorbers being the sound absorber of any one of embodiments 1-14 or the sound absorber assembly of any one of embodiments 15-17,
wherein the discrete sound absorbers each are attached to the annular rim surface, and the array of discrete sound absorbers are distributed along the circumferential direction of the annular rim surface.
   Embodiment 25 is the wheel rim of embodiment 24, wherein the flexible sheet-like base material of the at least one sound absorber is elongated along the circumferential direction of the annular rim surface.
   Embodiment 26 is the wheel rim of embodiment 24 or 25, wherein the discrete sound absorbers each are attached to the inner surface of the annular rim surface via an adhesive layer.
   Embodiment 27 is the wheel rim of any one of embodiments 24-26, wherein the array of discrete sound absorbers includes at least two, at least three, at least four, at least five, or optionally, at least six of the sound absorbers.
   Embodiment 28 is the wheel rim of any one of embodiments 24-27, wherein the array of discrete sound absorbers has a total length along the circumferential direction of the annular rim surface in the range from 1% to 100% of a circumferential length of the annular rim surface.
   Embodiment 29 is the wheel rim of any one of embodiments 24-28, wherein the sound absorbing material of the adjacent sound absorbers are separated by a gap, the gap having a length along the circumferential direction of the annular rim surface in the range from 1% to 99% of a circumferential length of the annular rim surface.
   Embodiment 30 is a wheel comprising the pneumatic tire of any one of embodiments 18-23.
   Embodiment 31 is a wheel comprising the wheel rim of any one of embodiments 24-29.
   Embodiment 32 is method of reducing tire cavity noise, the method comprising:
attaching an array of discrete sound absorbers to at least one of (i) an inner surface of an annular tread portion of a pneumatic tire, and (ii) an annular rim surface of a wheel rim,
wherein the pneumatic tire is mounted to the wheel rim to form an enclosed tire cavity, and
wherein at least one of the sound absorbers is the sound absorber of any one of embodiments 1-14 or the sound absorber assembly of any one of embodiments 15-17.
   Embodiment 33 is the method of embodiment 32, further comprising mounting at least one of the pneumatic tire and the wheel rim to an automobile.
   Embodiment 34 is the method of embodiment 33, wherein the automobile includes at least one of a passenger car, a bus, a truck, or a trailer.

The operation of the present disclosure will be further described with regard to the following detailed examples. These examples are offered to further illustrate the various specific and preferred embodiments and techniques. It should be understood, however, that many variations and modifications may be made while remaining within the scope of the present disclosure.

### Examples

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

### Test Methods

To evaluate the performance of different acoustic treatment, an acoustic test method called “tire cavity resonance tube” is developed. In the test, a straight tube with 20 cm×20 cm inner cross section is used to simulate the half tire cavity. Consequently, the length of the straight tube is equal to the half mean length of the annular tire cavity. The length of the straight tube is directly related to the resonance frequency of the tire cavity, which is given by

$$\\ {f}_{1} = \frac{343 m / s}{2 * L} ,$$

where f₁ is the resonance frequency of the first cavity mode and L is the length of the tube. In the test, the length of the straight tube is set to be 1 m, indicating a tire that has a mean length of the annular tire cavity of 2 m. The corresponding tire cavity resonance frequency is 171.5 Hz, which is a common resonance frequency for many large tires.

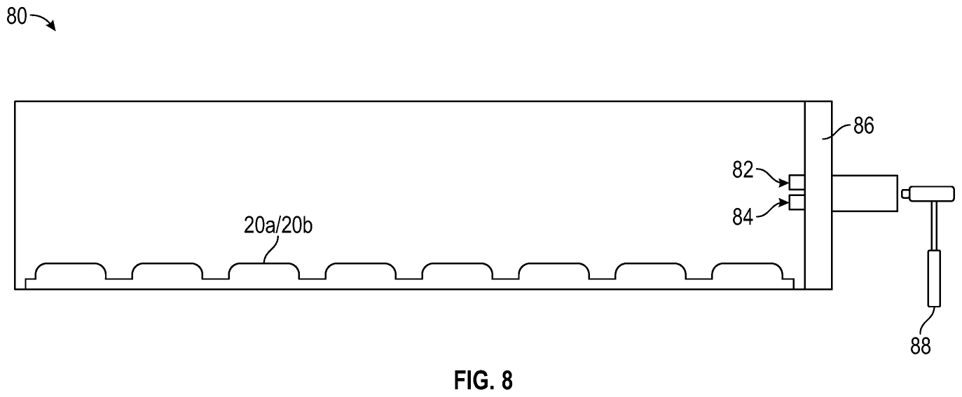

FIG. 8 is a schematic front view of the acoustic test setups. One end of the straight tube is closed, and the other end closed by a piston panel. The position of the piston panel 86 can be adjusted according to different tire sizes. On the piston panel, an accelerometer 82 and a microphone 86 are mounted at the center of the piston panel. During the test, a pulse force is applied at the center of the piston panel by using a force hammer 86. The acceleration response and the sound pressure response at the center of the piston are respectively measured by the accelerometer 82 and the microphone 86. The amplitude of the frequency response function between the sound pressure response and the acceleration response is finally determined and used for calculating the loss factor at the first cavity mode. The loss factor is calculated based on “half power” method according to the damping measurement standard ISO 16940. The higher loss factor, the more energy dissipation introduced by the corresponding acoustic treatment, i.e., the sound absorbers 20a/20b disposed in the tube.

### Examples and Comparative Examples

To compare the acoustic performance of the discrete sound absorber of the present disclosure with the typical PU foam solution in the market, the following examples and comparative examples are tested. The benchmark is case where no acoustic treatment is applied in the tube. Comparative Example 1 uses a continuous layer of PU foam bonding on the bottom surface of the straight tube. The longitudinal length, width and height of the PU foam are 1 m, 150 mm and 25 mm, respectively. The PU foam has a bulk density of 50 kg/m³ and has a flow resistivity of 8000 mks rayls/m. Comparative Example 2 uses the same PU foam material as in Comparative example 1. In Comparative Example 2, 9 PU foam members are evenly distributed along the tube length direction and bonded on the bottom surface of the straight tube. The longitudinal length, width and height of each PU foam members are 70 mm, 150 mm and 25 mm. The gap between two adjacent PU foam members is 10 mm. Comparative Example 3 uses the same PU foam material as in comparative example 1. In comparative example 3, the thickness of the continuous PU foam layer is increased to 40 mm.

Example 1 uses the discrete sound absorber(s) of the present disclosure. An assembly of 9 discrete sound absorbers are bonded on the bottom surface of the tube. Each sound absorber has the same structure. The screen material is made from 0.1 mm TPU film. It has an areal density of 60 g/m² and is air impermeable. It is to be understood that the air-impermeable screen material can increase the low frequency absorption of the sound absorbing material. The sound absorbing material is made from the polyester fiber material. It has a flow resistivity of 6000 rayls/m and an areal density of 400 g/m². The longitudinal length, width and height of the sound absorbing material are 70 mm, 150 mm and 25 mm. The base material is made from 0.1 mm PU film. It has an areal density of 60 g/m². The screen material and sound absorbing material were not attached or bonded, introducing a loose connection between them, which further increases the low frequency absorption. The gap between two adjacent sound absorbers is 10 mm.

Example 2 uses the same discrete layout, the same screen material and the same base material as in Example 1. Different from Example 1, the sound absorbing material of Example 2 in each sound absorber patch is composed of two layers of different sound materials. The top layer, which is facing to the screen material, is a 13 mm-thick polypropylene fiber layer. It has a flow resistivity of 1100 mks rayls/m and an areal density of 96 g/m². The bottom layer, which is facing to the base material, is a 12 mm-thick polyester fiber layer. It has a flow resistivity of 5000 mks rayls/m and an areal density of 300 g/m². The top layer has a lower flow resistivity than the bottom layer, which is beneficial for the low frequency absorption. When the sound absorbers are bonded to the tire tread portion, the bottom layer provides the stiffness resistance to the centrifugal force as the wheel is rolling. The top layer and bottom layer were not bonded.

### Test Results

The loss factor at the first cavity mode of each case was measured and used for comparison purpose. The test results are listed in Table 1 below. The total weight of each case is listed in the third column of the table. By comparing Comparative Example 1 and Example 1 or 2, it was found that the discrete sound absorber of the present disclosure can achieve 78% increase in loss factor, indicating a better acoustic performance than the typical PU foam solution in the market. In addition to the acoustic performance, the discrete sound absorber of the present disclosure can achieve 66.5% reduction in total weight, which is beneficial for the fuel efficiency of the tire. By comparing Comparative Example 2 and Example 1 or 2, it was found that, even with the same layout, the discrete sound absorber(s) of this disclosure show a much higher loss factor than the discrete PU members. By comparison between Comparative Example 3 and Example 1 or 2, it was found that even when the thickness of the continuous PU foam layer is increased to 40 mm, its loss factor is still lower than the discrete sound absorber.

TABLE 1

| | | | Total |
|---|---|---|---|
| | | Loss | Weight |
| Sample Name | Configuration | Factor (%) | (gram) |
| Benchmark | No treatment | 0.02 | 0 |
| Comparative | 25 mm PU Foam/Continuum | 4.36 | 188 |
| Example 1 | | | |
| Comparative | 25 mm PU Foam/Discrete | 4.16 | 150 |
| Example 2 | layout | | |
| Comparative | 40 mm PU Foam/Continuous | 7.22 | 300 |
| Example 3 | | | |
| Example 1 | Discrete Sound Absorber | 7.78 | 63 |
| Example 2 | Discrete Sound Absorber | 7.76 | 62 |

Reference throughout this specification to “one embodiment,” “certain embodiments,” “one or more embodiments,” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment,” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g., 1 to 5 includes 1, 1.5, 2, 2.75, 3, 3.80, 4, and 5). In addition, all numbers used herein are assumed to be modified by the term “about.” Furthermore, various exemplary embodiments have been described. These and other embodiments are within the scope of the following claims.

1. A sound absorber comprising:
a flexible sheet-like base material;
a sheet-like screen material; and
a sound absorbing material disposed in a closed space formed by the sheet-like base material and the sheet-like screen material, the sound absorbing material extending along a longitudinal direction of the sound absorber.

2. The sound absorber of claim 1, wherein the flexible sheet-like base material has a stretchability along the longitudinal direction no less than about 105%, no less than about 110%, optionally, no less than about 115%.

3. The sound absorber of claim 1, wherein the flexible sheet-like base material comprises at least one of rubber film, polyurethane (PU) film, thermoplastic polyurethane (TPU) film, polypropylene (PP) film, cast polypropylene (CPP) film, polyethylene terephthalate (PET), cast polyethylene terephthalate (CPET) film, or TPU/PU coated fabric.

4. The sound absorber of claim 1, wherein the sheet-like screen material has a flow resistivity no less than 0.01 mks rayls, no less than 1 mks rayls, optionally, no less than 1000 mks rayls.

5. The sound absorber of claim 1, wherein the sheet-like screen material comprises at least one of mesh fabric, nonwoven fabric, woven fabric, rubber film, polyurethane (PU) film, thermoplastic polyurethane (TPU) film, polypropylene (PP) film, cast polypropylene (CPP) film, polyethylene terephthalate (PET) film, cast polyethylene terephthalate (CPET) film, or TPU/PU coated fabric.

6. The sound absorber of claim 1, wherein one or more vent holes are formed on the sheet-like screen material.

7. The sound absorber of claim 1, wherein the sound absorbing material comprises at least one of polyurethane (PU) foam, glass fiber material, mineral fiber material, polyester fiber material, polypropylene fiber material, nonwoven fiber material embedded with sound absorbing particles, or a combination thereof.

8. The sound absorber of claim 1, wherein the sound absorbing material has a flow resistivity in a range from about 1000 mks rayls/m to about 50000 mks rayls/m, optionally, from about 4000 mks rayls/m to about 6000 mks rayls/m.

9. The sound absorber of claim 1, wherein the sound absorbing material has a thickness in a range from about 0.5 mm to about 200 mm, from about 2 mm to about 100 mm, optionally, from about 5 mm to about 50 mm.

10. The sound absorber of claim 1, further comprising an adhesive layer disposed on the flexible sheet-like base material.

11. A sound absorber assembly comprising a plurality of the sound absorbers of claim 1, wherein the sound absorbing material of the adjacent sound absorbers are separated by a gap.

12. The sound absorber assembly of claim 11, wherein the plurality of the sound absorbers is connected by a connection portion.

13. The sound absorber assembly of claim 12, wherein the connection portion comprises substantially no sound absorbing material.

14. A pneumatic tire comprising:
an annular tread portion extending in a circumferential direction thereof; and
an array of discrete sound absorbers, at least one of the sound absorbers being the sound absorber of claim 1,
wherein the discrete sound absorbers each are attached to an inner surface of the annular tread portion, and the array of discrete sound absorbers are distributed along the circumferential direction of the tread portion.

15. The pneumatic tire of claim 14, wherein the discrete sound absorbers each are attached to the inner surface of the annular tread portion via an adhesive layer.

16. (canceled)

17. The pneumatic tire of claim 13, wherein the sound absorbing material of the adjacent sound absorbers are separated by a gap, the gap having a length along the circumferential direction of the tread portion in the range from 1% to 99% of a circumferential length of the inner surface of the tread portion.

18. A wheel rim comprising:
an annular rim surface extending in a circumferential direction thereof; and
an array of discrete sound absorbers, at least one of the sound absorbers being the sound absorber of claim 1,
wherein the discrete sound absorbers each are attached to the annular rim surface, and the array of discrete sound absorbers are distributed along the circumferential direction of the annular rim surface.

19. The wheel rim of claim 18, wherein the discrete sound absorbers each are attached to the inner surface of the annular rim surface via an adhesive layer.

20. (canceled)

21. The wheel rim of claim 18, wherein the sound absorbing material of the adjacent sound absorbers are separated by a gap, the gap having a length along the circumferential direction of the annular rim surface in the range from 1% to 99% of a circumferential length of the annular rim surface.

22. (canceled)

23. A method of reducing tire cavity noise, the method comprising:
attaching an array of discrete sound absorbers to at least one of (i) an inner surface of an annular tread portion of a pneumatic tire, and (ii) an annular rim surface of a wheel rim,
wherein the pneumatic tire is mounted to the wheel rim to form an enclosed tire cavity, and
wherein at least one of the sound absorbers is the sound absorber of claim 1.

24. (canceled)

25. (canceled)
